(19) United States
(12) Patent Application Publication
(10) Pub. No.: US 2010/0323272 A1
(43) Pub. Date: Dec. 23, 2010

(54) CARBON CATALYST, SLURRY CONTAINING THE CARBON CATALYST, PROCESS FOR PRODUCING CARBON CATALYST, AND FUEL CELL, STORAGE DEVICE, AND ENVIRONMENTAL CATALYST EACH EMPLOYING CARBON CATALYST

(75) Inventors: Jun-ichi Ozaki, Kiryu-shi (JP); Terukazu Sando, Kiryu-shi (JP); Shinichi Horiguchi, Chiba-shi (JP); Takeaki Kishimoto, Chiba-shi (JP); Kazuo Saito, Chiba-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: NATIONAL UNIVERSITY CORPORATION GUNMA UNIVERSITY, Maebashi-shi (JP); Nisshinbo Holdings Inc., Tokyo (JP)

(21) Appl. No.: 12/851,836

(22) Filed: Aug. 6, 2010

Related U.S. Application Data
(63) Continuation of application No. PCT/JP08/71393, filed on Nov. 26, 2008.

(30) Foreign Application Priority Data
Feb. 6, 2008 (JP) 2008-027022
May 26, 2008 (JP) 2008-136828

(51) Int. Cl. B01J 21/18; C01B 31/02; C01B 21/082; C01B 31/36; C01B 31/30; H01M 8/10; B32B 5/16

(52) U.S. Cl. 429/484; 423/445 R; 423/384; 423/291; 502/180; 423/439; 423/440; 428/402; 977/775; 977/734

(57) ABSTRACT

The present invention is made to provide a carbon catalyst capable of preventing the coarsening of particles of nanoshell structure of carbon which causes reduction in activity for oxygen reduction reaction. The carbon catalyst is produced by the steps of: preparing a carbon precursor polymer; mixing a transition metal or a compound of the transition metal into the carbon precursor polymer; spinning the mixture of the carbon precursor polymer and the transition metal or the compound of the transition metal into fibers; and carbonizing the fibers.

### CROSS REFERENCES TO RELATED APPLICATIONS

The present invention contains subject matter related to Japanese Patent Application JP 2008-27022 and Japanese Patent Application JP 2008-136828 respectively filed in the Japanese Patent Office on Feb. 6, 2008 and May 26, 2008, the entire contents of which being incorporated herein by reference.

### BACKGROUND OF THE INVENTION

1. Field of the Invention

The present invention relates to a carbon catalyst carrying no noble metal such as platinum, platinum alloy or the like, and also relates to a slurry containing the carbon catalyst, a method for producing the carbon catalyst, and a fuel cell, an electric storage device and an environmental catalyst each using the carbon catalyst.

2. Description of the Related Art

As one of the important solutions to global warming problem and environmental pollution problem, practical use of high-efficiency and pollution-free fuel cell has been attracting much attention.

Particularly, in order to realize practical use of a proton-exchange membrane fuel cell employed in a fuel-cell electric vehicle, a stationary combined gasification-fuel cell system (CG-FC) or the like, one of the problems needing to be overcome is reducing usage of platinum catalyst. This is because a large amount of platinum catalyst is required to accelerate oxidation-reduction reaction occurring at the cathode of the fuel cell, and the large amount of platinum catalyst leads to a high cost.

As a technique for forming a catalyst without using platinum, a carbon catalyst is proposed which contains carbon particles of nanoshell structure (also referred to as “nanoshell carbon”) (see, for example, Japanese Unexamined Patent Application Publication No. 2003-249231, Japanese Unexamined Patent Application Publication No. 2007-26746, and Japanese Unexamined Patent Application Publication No. 2007-207662).

The nanoshell structure is a carbon structure formed by catalytic action of metal microparticles generated by the thermal decomposition during a carbonization process by previously adding an iron complex or a cobalt complex when making carbon material from an organic substance, and is defined as a structure in which a hollow shell having a diameter of several tens nm is formed by graphene.

Further, it is known that the carbon catalyst having the nanoshell carbon itself has activity for oxygen reduction reaction without using the platinum catalyst, and it is described that the activity for oxygen reduction reaction can be improved by calcining a precursor which is formed by introducing nitrogen atoms (N) and boron atoms (B) into the organic substance.

To be specific, the aforesaid carbon catalyst is obtained by mixing a transition metal complex containing a large amount of nitrogen atoms (N), such as phthalocyanine cobalt or the like, into a precursor of a resin excellent in thermosetting property and containing no nitrogen atom (N), such as phenol or the like, then polymerizing the precursor by performing a heat treatment to prepare a thermosetting resin, and then carbonizing the resin by further performing a heat treatment.

Further, by containing the transition metal and nitrogen atoms (N) into the aforesaid thermosetting resin, due to the catalytic action and the like of the transition metal, formation and growth of the graphene (in which nitrogen atoms (N) are coordinated) are inhibited, and thereby fine nanoshell carbon can be obtained.

### SUMMARY OF THE INVENTION

However, in the nanoshell carbon produced according to the method described in Japanese Unexamined Patent Application Publication No. 2007-207662, for example, due to cluster aggregation of a large amount of transition metal in the resin before carbonization, there is a possibility that a large amount of transition metal aggregated in clusters may be mixed into one carbonized nanoshell carbon. For this reason, there is a concern that the nanoshell structure may become coarse, and particle size of the nanoshell carbon may fall in a range of 50 to 100 nm. Further, the diameter of the nanoshell carbon contained in the aforesaid carbon catalyst is at least about 20 nm. Coarsening of particle size of the nanoshell carbon will reduce the defects on the surface of the carbon particle which contribute to development of activity for oxygen reduction reaction and, as a result, will reduce activity for oxygen reduction reaction.

As described above, in order to realize practical use of the carbon catalyst containing the carbon particles of nanoshell structure, it is necessary to obtain higher catalytic activity, and therefore it is strongly desired to obtain a carbon catalyst in which size of the nanoshell carbon is further reduced and in which the nanoshell carbon is densely-filled. Additionally, although the aforesaid nanoshell carbon is cheaper compared with platinum, it is further desired to select cheap transition metal or transition metal compound and reduce the cost of the method for introducing a nitrogen source and/or a boron source.

Further, the aforesaid carbon catalyst was invented to be mainly used as the cathode catalyst of a fuel cell, however it is strongly desired to invent a carbon catalyst capable of being used as an alternative to the anode platinum catalyst.

To solve the aforesaid problems, the present invention seeks to provide a carbon catalyst having excellent catalyst performance achieved by further reducing the size of the nanoshell carbon and increasing the density of the nanoshell carbon, and a method capable of producing such carbon catalyst at low cost.

A carbon catalyst according to an aspect of the present invention is formed in fibrous shape by carbon particles of nanoshell structure, and the carbon particles of nanoshell structure are provided with catalytic action. Further, it is preferred that the carbon particles of nanoshell structure, which constitute the carbon catalyst, contain a high concentration of nitrogen atoms (N) and boron atoms (B). Further, the carbon catalyst can be widely used as catalyst for various chemical reactions, particularly can be used as an alternative to a conventional platinum catalyst. For example, the carbon catalyst can be preferably used as the electrode catalyst for the fuel cell, the electrode material of the electric storage device, an exhaust gas purging catalyst, a catalyst for water treatment, a catalyst for hydrogenation reaction, a catalyst for dehydrogenation reaction, a catalyst for oxidation reaction, a catalyst for polymerization reaction, a catalyst for reforming reaction, and a steam reforming catalyst.

A slurry according to another aspect of the present invention comprises a solvent, and a carbon catalyst dispersed in the solvent, wherein the carbon catalyst is formed in fibrous shape by carbon particles of nanoshell structure, and wherein the carbon particles of nanoshell structure are provided with catalytic action.

A method for producing the carbon catalyst according to further another aspect of the present invention comprises the steps of: preparing a carbon precursor polymer; mixing a transition metal or a compound of the transition metal into the carbon precursor polymer; spinning the mixture of the carbon precursor polymer and the transition metal or the compound of the transition metal into fibers; and carbonizing the fibers to form carbon particles of nanoshell structure.

By mixing the transition metal into the carbon precursor polymer and carbonizing the mixture, the carbon particles of nanoshell structure are formed due to the catalytic action of the transition metal.

Further, it is possible to limit the size of the carbon particles of nanoshell structure within a predetermined range by spinning the carbon precursor polymer before carbonization.

Further, by preventing coarsening of the nanoshell carbon, it is possible to prevent reduction of activity for oxygen reduction reaction caused by reduction of defects on the surface of the carbon particles which contribute to development of activity for oxygen reduction reaction.

A fuel cell according to further another aspect of the present invention comprises a solid electrolyte and two electrode catalysts facing each other with the solid electrolyte interposed therebetween, wherein at least one of the electrode catalysts includes a carbon catalyst which is formed in fibrous shape by carbon particles of nanoshell structure, and wherein the carbon particles of nanoshell structure are provided with catalytic action.

An electric storage device according to further another aspect of the present invention comprises an electrode material and an electrolyte, wherein the electrode material includes a carbon catalyst formed in fibrous shape by carbon particles of nanoshell structure, and wherein the carbon particles of nanoshell structure are provided with catalytic action.

An environmental catalyst according to further another aspect of the present invention is used for removing contaminated material by performing degradative treatment, and comprises a carbon catalyst formed in fibrous shape by carbon particles of nanoshell structure, wherein the carbon particles of nanoshell structure are provided with catalytic action.

By containing the carbon particles of nanoshell structure, the aforesaid carbon catalyst is provided with carbon catalyst such as activity for oxygen reduction reaction and the like. Thus, the aforesaid carbon catalyst can be widely used in various chemical reactions, particularly can be used as an alternative catalyst to a platinum catalyst, on which a noble metal such as platinum is supported, to perform oxidation-reduction reactions and the like to obtain desired chemical substances. Particularly, by applying the aforesaid carbon catalyst to the electrode catalyst of the fuel cell, it is possible to reduce oxygen at the cathode of the fuel cell to generate water or hydrogen peroxide to improve oxidation-reduction reaction without using a conventional platinum catalyst.

Further, the aforesaid carbon catalyst has a fibrous structure formed by aggregated nanoshell carbon, and therefore the specific surface area is increased. The increase of the specific surface area is particularly remarkable when the fiber diameter is in nanometer, particularly when the fiber diameter is within a range of 10 to 1000 nm. For this reason, by applying the aforesaid carbon catalyst to the electrode material of the electric storage device, the size of an electrode interface (an interface charges accumulate) can be increased, and therefore the electric storage capacity per unit volume of the electrode can be increased.

Further, due to catalytic action of the nanoshell carbon, the aforesaid carbon catalyst has degradation function for degrading material-to-be-treated such as the contaminated material. Thus, since the noble metal such as platinum is unnecessary to be used to configure the environmental catalyst with the aforesaid carbon catalyst, it is possible to provide a low-cost environmental catalyst.

Further, since the specific surface area is large, treatment area (in which the material-to-be-treated is degraded) per unit volume can be increased, and therefore it is possible to provide an environmental catalyst excellent in degradation function per unit volume.

According to the carbon catalyst, the slurry containing the carbon catalyst, and the method for producing the carbon catalyst of the present invention, it is possible to control the thickness of the graphene layer, which constitutes the carbon particles of nanoshell structure which further constitute the carbon catalyst, to a range of 1 to 10 nm, preferably to a range of 1 to 5 nm, and further, it is possible to reduce the size of the carbon particles of nanoshell structure, which constitute the carbon catalyst, to a range of 5 to 50 nm, preferably to a range of 5 to 20 nm, and more preferably to a range of 5 to 10 nm, therefore not only the chemical reaction activity is increased (among this, the activity for oxygen reduction reaction is dramatically increased), but also the hydrogen oxidation activity can be developed.

Further, with the fuel cell of the present invention, by using the carbon catalyst, which has fibrous structure containing carbon particles of nanoshell structure, as the electrode catalyst, the oxygen reduction reaction of the cathode of the fuel cell can be improved by inexpensive electrode catalyst.

Further, with the fuel cell of the present invention, by applying the carbon catalyst, which has fibrous structure containing carbon particles of nanoshell structure, to the electrode catalyst, the oxidation reaction of the anode of the fuel cell can be improved by inexpensive electrode catalyst.

Further, with the fuel cell of the present invention, by forming the carbon catalyst, which has fibrous structure containing carbon particles of nanoshell structure, into nonwoven fabric, the carbon catalyst can also be used as a gas diffusion layer which has catalytic activity, therefore the volume of the fuel cell can be reduced.

Further, with the electric storage device of the present invention, by applying the carbon catalyst, which has fibrous structure containing carbon particles of nanoshell structure, to the electrode material, the electric storage capacity per unit volume can be increased.

Further, with the electric storage device of the present invention, by applying the carbon catalyst, which has fibrous structure containing carbon particles of nanoshell structure, to the electrode material, it is possible to regulate the potential within a suitable range so as to prolong the service life of the electric storage device.

Further, with the environmental catalyst of the present invention, by applying the carbon catalyst, which has fibrous structure containing carbon particles of nanoshell structure, to the catalyst material, it is possible to remove contaminated material with inexpensive catalyst material.

### BRIEF DESCRIPTION OF THE DRAWINGS

FIG. 1 is a view showing a fuel cell having an electrode catalyst to which a carbon catalyst according to the present invention is applied;

FIG. 2 is a view showing an electric double layer capacitor having electrodes to which the carbon catalyst according to the present invention is applied;

FIG. 3 is a view schematically showing a three-electrode cell used to perform an electrocatalytic activity test for oxygen reduction;

FIG. 4 is a scanning electron microscope photograph of a nanofiber nonwoven fabric for producing a carbon catalyst according to Example 1;

FIG. 5 is a scanning electron microscope photograph of carbonized nanofibers for producing the carbon catalyst according to Example 1;

FIG. 6 is a transmission electron microscope photograph of the carbonized nanofibers for producing the carbon catalyst according to Example 1;

FIG. 7 is a photograph obtained by further enlarging the transmission electron microscope photograph of FIG. 6;

FIG. 8 is a scanning electron microscope photograph of the carbon catalyst according to Example 1;

FIG. 9 is an X-ray diffraction spectrum of the carbon catalyst according to Example 1; and

FIG. 10 shows voltammograms obtained based on the electrocatalytic activity tests performed on Example 1, Comparative Example 1 and Comparative Example 2.

### DETAILED DESCRIPTION OF THE PREFERRED EMBODIMENT(S)

An embodiment of the present invention will be described below in detail.

A carbon catalyst according to the present embodiment is formed in fibrous shape, and at least a part thereof contains carbon particles of nanoshell structure.

The carbon catalyst according to the present embodiment is produced by spinning a carbon precursor polymer into fibers by a spinning method such as a dry spinning method, a wet spinning method, an electrospinning method or the like, and carbonizing the carbon precursor polymer fibers, wherein the carbon precursor polymer contains nitrogen atoms (N) as a constituent element, and has a transition metal or a transition metal compound added therein. At this time, carbon particles of nanoshell structure containing a high concentration of nitrogen atoms (N) are formed due to the catalytic action and the like of the transition metal or transition metal compound added to the carbon precursor polymer, which contains nitrogen atoms (N) as a constituent element.

The following can be considered as factors contributing to high activity of the nanoshell carbon of the present embodiment. The basic structure of the nanoshell carbon is a structure formed by spherically laminating graphene layers, which are each an aggregation of carbon atoms bonded together through sp²-hybridized orbitals to form a two-dimensional hexagonal network structure. When nitrogen atoms (N) are introduced into the hexagonal network structure in the carbonization process, pyrrole nitrogen atoms, pyridine nitrogen atoms, and oxidized nitrogen atoms are coordinated, and defects of the graphene structure caused by chemical bonding of different elements shows catalytic activity. In other words, the excellent catalytic activity of the present embodiment is caused by increasing surface area by reducing the particle size of the nanoshell carbon to 50 nm or less, preferably to 20 nm or less, more preferably to 10 nm or less, by forming the nanoshell carbon in fibrous shape so as to increase surface area, and further, by making a high concentration of nitrogen atoms (N) exist on the surface of the nanoshell carbon.

It is considered that the miniaturization of the nanoshell structure is realized by reducing the thickness of the graphene layer of the nanoshell carbon of the present embodiment to 10 nm or less, and preferably to 5 nm or less. It is considered that the aforesaid thickness of the graphene layer improves bendability of the graphene, and promotes the formation of the nanoshell carbon having smaller particle size. Additionally, due to the improved bendability, the nanoshell carbon of the present embodiment may show many extremely-strained shapes such as elliptic shape, flat shape, triangular shape and the like, in addition to the spherical shape.

A method for producing a fibrous shaped carbon catalyst by aggregating a part or all of the carbon particles of the aforesaid nanoshell structure will be described below.

First, a carbon precursor polymer is prepared. The carbon precursor polymer is not particularly limited as long as it is a polymer material capable of being carbonized by thermal curing. Examples of the carbon precursor polymer include polyacrylonitrile (PAN), chelating resin, cellulose, carboxymethyl cellulose, polyvinyl alcohol, polyacrylic acid, polyfurfuryl alcohol, fran resin, phenol resin, phenol-formaldehyde resin, melamine resin, pitch, brown coal, polyvinylidene chloride, lignin and the like.

Further, the carbon precursor polymer suitable to the present embodiment may be prepared even from a polymer material unsuitable to be carbonized if such polymer material is mixed or copolymerized with a polymer material which prompts cross-linking. For example, acrylonitrile (AN) and methacrylate (MA) can be used to prepare a polyacrylonitrile-polymethacrylic acid copolymer (PAN-co-PMA) by using a known soap-free polymerization method.

Further, it is preferred that the carbon precursor polymer contains nitrogen atoms (N) as a constituent element thereof. Particularly, it is preferred that the carbon precursor polymer contains a high concentration of nitrogen atoms (N) as a constituent element thereof, such as polyacrylonitrile (PAN). It is preferred that the content of the nitrogen atoms (N) contained in the carbon precursor polymer is within a range of 0.5 to 30% by mass based on the total weight of the carbon catalyst.

By using the carbon precursor polymer containing the nitrogen atoms (N) within the aforesaid content range, it is not necessary to separately introduce a compound as a nitrogen source, and further, it is possible to reduce the size of the carbon particles of nanoshell structure. Thus, the capacity of the activity for oxygen reduction reaction of the carbon catalyst can be improved.

Further, for example, in the aforesaid polyacrylonitrile-polymethacrylic acid copolymer (PAN-co-PMA), if the content of PMA exceeds 15 mol %, fusion of fibers with each other will be caused when performing infusibilization treatment, fiber diameter will become large when carbonizing the fibers, and/or thermal decomposition will prevail over carbonization when carbonizing the carbon precursor polymer, so that it will be impossible to obtain the nanoshell carbon. Further, it is considered that if the content of PAN is higher and the content of PMA is lower, the carbon catalyst will contain more amount of nitrogen atoms (N), and therefore it is possible to improve the capacity of the activity for oxygen reduction reaction of the carbon catalyst. However, the carbon catalyst produced from a carbon precursor polymer in which the content of PMA is less than 5 mol % indicates decreased reduction current of the oxygen reduction voltammogram, which represents activity for oxygen reduction reaction. Thus, in the PAN-co-PMA, it is preferred that the content of PMA is within a range of 5 to 15 mol %.

Next, the carbon precursor polymer prepared in the aforesaid manner and a transition metal or transition metal compound are dissolved in a solvent to prepare a solution for spinning.

A solvent capable of dissolving the carbon precursor polymer and capable of being applied to a fiber-forming process of the carbon precursor polymer is suitably selected.

If the transition metal or transition metal compound can not be dissolved in the solvent, it is preferred that a solvent having excellent dispersibility is used.

After the transition metal or transition metal compound is dispersed in the solvent, the aforesaid carbon precursor polymer is dissolved in the solvent. Further, the carbon precursor polymer dissolved in the solvent and the transition metal or transition metal compound are kneaded with each other, and thereby the solution for spinning is prepared.

For example, in the case where the aforesaid PAN-co-PMA is used as the carbon precursor polymer and cobalt oxide is used as the transition metal compound, at least one substance selected from the following group can be used as the solvent to prepare the uniform solution for spinning: N,N-dimethylformamide (DMF), N-Methyl-2-Pyrrolidone (NMP), or dimethylsulfoxide (DMSO).

An element belonging to the third to twelfth groups in the fourth period of the periodic table can be used as the transition metal. For example, it is preferred that the transition metal is selected from a group consisting of cobalt (Co), iron (Fe), manganese (Mn), nickel (Ni), copper (Cu), titanium (Ti), chromium (Cr) and zinc (Zn).

Further, a salt, a hydroxide, an oxide, a nitride, a sulfide, a carbide, or a complex of the aforesaid transition metal can be used as the transition metal compound, and it is preferred that, among these substances, a compound selected from a group consisting of cobalt chloride, cobalt oxide, cobalt hydroxide, phthalocyanine cobalt, iron chloride, iron oxide and phthalocyanine iron is used as the transition metal compound.

Co, Fe, Mn, Ni, Cu, Ti, Cr, Zn and the compounds thereof are excellent in forming the nanosize shell structure which improves catalytic activity of the carbon catalyst, and among these substances, Co and Fe are particularly excellent in forming the nanosize shell structure. Further, Co and Fe contained in the carbon catalyst improve catalytic activity for oxygen reduction reaction in the carbon catalyst.

Further, it is preferred that the particle size of the transition metal or transition metal compound is within a range of 1 to 50 nm in diameter, preferably within a range of 1 to 20 nm, and more preferably within a range of 1 to 10 nm. By reducing the particle size of the transition metal or transition metal compound, breakage of the fibers and release of the transition metal or transition metal compound can be inhibited. Further, by reducing the particle size of the transition metal or transition metal compound to a size equal to or smaller than the diameter of the nanoshell carbon constituting the carbon catalyst, it is possible to form finer nanoshell structure and, at the same time, to inhibit coarsening caused by development of the graphene layer.

Incidentally, the aforesaid transition metal or transition metal compound can be produced using a known method, however, for purpose of obtaining nanosized particles having uniform size, it is preferred that the aforesaid transition metal or transition metal compound is produced using a method described in, for example, International Publication No. 2007/049549 or Japanese Unexamined Patent Application Publication No. 2007-332436.

Next, the aforesaid solution for spinning is spun into fibers by using a known spinning method such as, for example, a dry spinning method, a wet spinning method, an electrospinning method, a polymer blend centrifugal spinning method, a melt-blowing method, a melt-spinning method or the like, wherein the produced fibers have a diameter of 0.01 to 1000 μm.

In order to further improve the catalytic activity, it is preferred that the fiber diameter is reduced as much as possible. For this purpose, it is preferred that an electrospinning method is used, which can produce fibers having a diameter of 10 to 1000 nm. Further, the electrospinning method is a spinning method in which an electric field is applied to droplets of the solution for spinning. An advantage of the electrospinning method is that it can be used to produce nanofibers (ultrafine fibers whose diameter is measured in nanometer) having highly uniform fiber diameter.

Further, a nonwoven fabric is made from the produced fibers. At this time, a nanofiber nonwoven fabric can be produced if the fibers are nanofibers.

It is preferred that the diameter of the aforesaid fibers is within a range of 0.01 to 1000 μm. It is particularly preferred that the diameter of the aforesaid fibers is within a range of 0.01 μm to 1000 nm. If the diameter of the fibers exceeds 1000 μm, there is a possibility that, when carbonizing the fibers, the particle size of the nanoshell carbon may become larger due to reduction of effect for spatially inhibiting molecular migration, and therefore causing coarsening of the nanoshell carbon. Further, if the diameter of the fibers is less than 0.01 μm, there is a possibility that, when carbonizing the fibers, the nanoshell structure of the carbon particles may become poorly developed.

Further, in order to form the nanoshell carbon, it is preferred that the diameter of the fibers is within a range of 10 to 1000 nm. By controlling the diameter of the fibers to a range of 10 to 1000 nm, it is possible to easily form the nanoshell carbon having a particle size within a desired range (which is to be described later).

Next, in the case where a polymer material with poor thermosetting property is used as the carbon precursor polymer, it is possible to perform an infusibilization treatment on the fibers. By performing the infusibilization treatment on the fibers, the fibrous structure of the resin can be maintained even under a temperature equal to or higher than the melting point or softening point of the carbon precursor polymer.

The infusibilization treatment of the nonwoven fabric is performed by heating the nonwoven fabric to a temperature not higher than the melting point or softening point of the carbon precursor polymer in the air to oxidize and cross-link the carbon precursor polymer. Further, the infusibilization treatment may also be performed by using a known infusibilization method, instead of using the aforesaid method. By performing the infusibilization treatment, when the carbon precursor polymer fibers are subjected to a heat treatment in a carbonization process (which is to be described later), collapse of fiber shape, fusion of fibers with each other and the like caused by melting of the polymer can be prevented.

For example, the infusibilization treatment of the aforesaid PAN-co-PMA is performed by raising the temperature of the PAN-co-PMA fibers in the air from room temperature to 150° C. over 30 minutes, then raising the temperature from 150 to 220° C. over 2 hours, and then maintaining the temperature at 220° C. for 3 hours.

Next, the infusibilized nonwoven fabric is carbonized by being heated under a flow of an inert gas such as nitrogen gas at a temperature of 500° C. to 1500° C., preferably 900° C. to 1000° C., for a holding time of 5 minutes to 180 minutes, preferably 20 minutes to 120 minutes. At this time, due to the catalytic action of the transition metal contained in the carbon precursor polymer, the carbon particles of nanoshell structure are formed in the fibers.

If the carbonization temperature is lower than 500° C., the carbonization of the carbon precursor polymer will be insufficient; while if the carbonization temperature is higher than 1500° C., the defects on the surface of the carbon particles will be eliminated along with crystal growth of the carbon particles of nanoshell structure.

Further, if the holding time is shorter than 5 minutes, it will be impossible to evenly perform the heat treatment on the nonwoven fabric. While if the holding time is longer than 180 minutes, the defects on the surface of the carbon particles will be eliminated along with crystal growth of the carbon particles of nanoshell structure.

Further, it is preferred that, in the aforesaid carbonization process, the temperature is raised to the aforesaid temperatures at a rate of 10 to 30° C./min.

If the rate of temperature rise is less than 10° C./min or the carbonization temperature is higher than 1500° C., the reaction time of the carbonization will be too long, and therefore the defects on the surface of the carbon particles will be eliminated along with crystal growth of the carbon particles of nanoshell structure. While if the rate of temperature rise is more than 30° C./min or the carbonization temperature is shorter than 500° C., the reaction time of the carbonization will be too short, and therefore the carbonization will be insufficient.

If the carbonization is insufficient, sufficient activity can not be provided to the carbon catalyst. Further, if the defects on the surface of the carbon particles are eliminated, the activity will be reduced.

It is preferred that the thickness of the graphene layer of the nanoshell carbon formed in the aforesaid carbonization process is within a range of 1 to 10 nm, and preferably 1 to 5 nm.

Further, it is preferred that the diameter of the nanoshell carbon formed in the aforesaid carbonization process is within a range of 5 to 50 nm, preferably within a range of 5 to 20 nm, and more preferably within a range of 5 to 10 nm. In the case where the diameter of the nanoshell carbon exceeds 50 nm, the nanoshell structure of the carbon particles will be overdeveloped, and the defects on the surface of the carbon particles, which contribute to development of activity, will be reduced. Thus, in the aforesaid carbon catalyst, lower activity will be resulted.

Further, in the aforesaid carbon catalyst, it is possible to perform carbon dioxide (CO₂) activation on the nanoshell carbon to improve the catalytic activity.

It is possible to perform CO₂ activation on the surface of the nanoshell carbon by holding the carbon catalyst under a flow of CO₂ at 300° C. to 1000° C. for 5 minutes to 180 minutes.

By performing CO₂ activation on the nanoshell carbon, it is possible to create defects on the surface of the nanoshell carbon and therefore increase efficient active site of the carbon catalyst. Further, low activity amorphous carbon can be removed from the structure of the carbon catalyst. Thus, it is possible to improve the activity of the carbon catalyst.

Further, by introducing nitrogen atoms (N), boron atoms (B) and boron nitride (BN) into the carbon catalyst, the activity for oxygen reduction reaction of the carbon catalyst can be improved.

Nitrogen atoms (N) can be introduced by using a liquid-phase doping method, a vapor-phase doping method, or a vapor-liquid-phases doping method. For example, the nitrogen atoms (N) can be introduced into the surface of the carbon catalyst by mixing ammonia, melamine, acetonitrile or the like (as a nitrogen source) into the carbon catalyst, and performing a heat treatment on the carbon catalyst by holding the carbon catalyst at a temperature of 550-1200° C. for 5-180 minutes under an inert gas atmosphere, such as an atmosphere of nitrogen (N₂), argon (Ar), helium (He) or the like.

Further, similar to the method for introducing the nitrogen atoms (N) as described above, the boron atoms (B) can be introduced into the carbon catalyst by using a liquid-phase doping method, a vapor-phase doping method, or a vapor-liquid-phases doping method. For example, the boron atoms (B) can be introduced into the carbon catalyst by bringing BCl₃ gas (as a boron source) into contact with the carbon catalyst, or by mixing BF3-methanol (as a boron source) with the carbon catalyst and then performing a heat treatment on the mixture by holding the temperature at 550-1200° C. for 5-180 minutes under an inert gas atmosphere, such as an atmosphere of nitrogen (N₂), argon (Ar), helium (He) or the like.

Further, using the aforesaid methods in combination, the boron atoms (B) can be introduced into the carbon catalyst along with the nitrogen source while introducing the nitrogen atoms (N) into the carbon catalyst, or the nitrogen atoms (N) can be introduced into the carbon catalyst along with the boron source while introducing the boron atoms (B) into the carbon catalyst.

Also, using the aforesaid methods in combination, the boron atoms (B) can be introduced into the carbon catalyst after the nitrogen atoms (N) has been introduced into the carbon catalyst, or the nitrogen atoms (N) can be introduced into the carbon catalyst after the boron atoms (B) has been introduced into the carbon catalyst.

By introducing nitrogen atoms (N), boron atoms (B) and/or boron nitride (BN) into carbon, development of the carbon structure is inhibited by the introduced atoms. Thus, in the nanoshell carbon, the ratio of the edge faces to the basal faces is increased, wherein the edge faces are perpendicular to the basal faces. The edge face is electronically and chemically active compared with the base face. Further, in the case where the nitrogen atoms (N) are introduced into the carbon catalyst, the number of electrons in the carbon catalyst will increase, while in the case where the boron atoms (B) are introduced into the carbon catalyst, the number of electrons in the carbon catalyst will decrease. Thus, by introducing nitrogen atoms (N) or boron atoms (B) into the carbon catalyst, the activity for oxygen reduction reaction of the carbon catalyst can be improved.

It is preferred that the total amount of nitrogen atom (N) and/or boron atom (B) introduced into the carbon catalyst (i.e., the total content of nitrogen atom (N) and/or boron atom (B) contained in the carbon catalyst) is within a range of 0.5 to 20% by mass, preferably within a range of 5 to 20% by mass based on the total weight of the carbon catalyst.

Next, the transition metal or transition metal compound contained in the carbon catalyst is removed by an acid or by performing an electrolytic treatment according to necessity.

The transition metal or transition metal compound mixed in the carbon precursor polymer is a substance necessary to form the nanoshell carbon in the aforesaid carbonization process. However, in the carbon catalyst, it is the nanoshell carbon that mainly has catalytic activity, therefore there is a case where the transition metal or transition metal compound becomes no longer necessary after the nanoshell carbon had been formed in the carbonization process. So that the transition metal or transition metal compound is removed by performing an acid treatment or electrolytic treatment on the carbon catalyst according to necessity. The removed transition metal or transition metal compound can be reused by recycling. Particularly, in the case where the carbon catalyst is used as anode catalyst of a fuel cell, since the transition metal will be eluted so as to decrease the oxidative activity and deteriorate a solid polymer membrane, it is necessary to remove the transition metal or transition metal compound before use.

Incidentally, after being used to form the nanoshell carbon, the aforesaid transition metal and transition metal compound can become a constituent part of the carbon catalyst. Particularly, in the case where the transition metal itself has catalytic action, the catalytic activity of the carbon catalyst can be improved.

With the carbon catalyst according to the present embodiment, by mixing the carbon precursor polymer with the transition metal and spinning it into fibers and then carbonizing the carbon precursor polymer, molecular motion in nano region is inhibited, and therefore extra development of the nanoshell carbon can be inhibited. This is at least because the nanoshell carbon does not grow to a size equal to or larger than the diameter of the fiber and by preventing coarsening of the nanoshell carbon, it is possible to finely reduce the particle size of the nanoshell carbon. Particularly, the aforesaid effect is more remarkable in the case where the diameter of the fibers (nanofibers) is within a range of 10 to 1000 nm.

Further, since the carbon catalyst can be formed of the nonwoven fabric that is produced using the fibrous carbon, the specific surface area per unit volume of the carbon catalyst is great. Thus, reaction area as a catalyst is increased, reaction area per unit volume is increased, and therefore catalytic activity is improved. Further, it is possible to further increase the specific surface area by crushing the carbon catalyst according to necessity.

As described above, with the carbon catalyst according to the present embodiment, by finely reducing the particle size of the nanoshell carbon and inhibiting the growth of the nanoshell carbon, it is possible to increase the surface of the carbon particles of nanoshell structure, which contributes to development of catalytic activity, and therefore develop high activity. Thus, the catalyst of the present invention can be widely used in various chemical reactions. For example, as an alternative catalyst to a platinum catalyst on which a noble metal such as platinum is supported, the catalyst of the present invention can be used in oxidation-reduction reactions and the like to obtain desired chemical substances. Particularly, by applying the aforesaid carbon catalyst to the electrode catalyst of a fuel cell, it is possible to reduce oxygen at the cathode of the fuel cell to generate water or hydrogen peroxide to improve oxygen reduction reaction without using a conventional platinum catalyst. Further, it is possible to improve oxidation reaction of hydrogen at the anode.

Further, it is possible to produce a slurry containing the carbon catalyst by dispersing the carbon catalyst according to the present embodiment in a solvent. Thus, for example, when producing the electrode catalyst of a fuel cell and the electrode material of an electric storage device, it is possible to coat the slurry, which is made by dispersing the carbon catalyst of the present embodiment in a solvent, on a support material, and firing and drying the coated slurry so as to form a carbon catalyst having arbitrary shape. Thus, by making the slurry from the carbon catalyst in the aforesaid manner, the workability of the carbon catalyst can be improved, and therefore it is possible to easily apply the carbon catalyst to the electrode catalyst, the electrode material and the like.

The solvent used for producing the electrode catalyst of the fuel cell and the electrode material of the electric storage device can be suitably selected. For example, the following generic polar solvents alone or in combination can be used as the solvent for producing the electrode material of the electric storage device: diethyl carbonate (DEC), dimethyl carbonate (DMC), 1,2-dimethoxyethane (DME), ethylene carbonate (EC), ethyl methyl carbonate (EMC), N-methyl-2-pyrrolidone (NMP), propylene carbonate (PC), γ-buthylrolactone (GBL) and the like. Further, examples of the solvent used for producing the electrode catalyst of the fuel cell include: water, methanol, ethanol, isopropyl alcohol, butanol, toluene, xylene, methyl ethyl ketone, acetone and the like.

Next, a fuel cell having an anode electrode and a cathode electrode to which the aforesaid carbon catalyst is applied will be described below.

FIG. 1 is a view showing a schematic configuration of a fuel cell 10 according to the present embodiment. The fuel cell 10 includes a solid polyelectrolyte 14, a separator 12, an anode catalyst (fuel electrode) 13, a cathode catalyst (oxidizer electrode) 15, and a separator 16, wherein the separator 12 and the anode catalyst (fuel electrode) 13 respectively face the separator 16 and the cathode catalyst 15 with the solid polyelectrolyte 14 interposed therebetween.

A fluorine-based cation-exchange resin membrane, typified by a perfluorosulfonic acid resin membrane, is used as the solid polyelectrolyte 14.

Further, the fuel cell 10 whose anode catalyst 13 and cathode catalyst 15 include the carbon catalyst is configured by bringing the aforesaid carbon catalyst, as the anode catalyst 13 and cathode catalyst 15, into contact with both sides of the solid polyelectrolyte 14.

By forming the aforesaid carbon catalyst on the both surfaces of the solid polyelectrolyte and bringing the anode catalyst 13 and cathode catalyst 15 into close contact with the both principal surfaces of the solid polyelectrolyte 14 at electrode reaction layer sides by hot pressing, these components are integrated as a MEA (Membrane Electrode Assembly).

Obviously the aforesaid carbon catalyst may be applied to either one of the anode catalyst 13 and cathode catalyst 15.

In a conventional fuel cell, a gas diffusion layer formed by a porous sheet (for example, a carbon paper) is interposed both between the separator and the anode catalyst and between the separator and the cathode catalyst, wherein the gas diffusion layer also functions as a current collector.

In contrast, in the fuel cell according to the present embodiment, the carbon catalyst having large specific surface area and high gas diffusivity can be used as the anode catalyst and/or the cathode catalyst, and therefore the carbon catalyst can be provided with the function of the gas diffusion layer, so that it is possible to configure a fuel cell in which the anode catalyst 13 and the gas diffusion layer is integrated, and/or the cathode catalyst 15 and the gas diffusion layer is integrated. Thus, it is possible to miniaturize the fuel cell and reduce cost by eliminating the gas diffusion layer.

The separator 12 and separator 16 are also adapted to supply and discharge reaction gases such as fuel gas H₂, oxidizer gas O₂ and the like, in addition to supporting the anode catalyst 13 and cathode catalyst 15. Further, when the reaction gases are respectively supplied to the anode catalyst 13 and the cathode catalyst 15, a triphasic interface of a gas phase (the reaction gas), a liquid phase (the solid polyelectrolyte membrane) and a solid phase (the catalyst of the both electrodes) is formed on the border between the carbon catalyst of the both electrodes and the solid polyelectrolyte 14. Further, a DC power is generated due to the occurrence of an electrochemical reaction.

In the aforesaid electrochemical reaction, the following reactions occur on the cathode side and the anode side:

Cathode side: O₂+4H⁺+4e⁻→2H₂O

Anode side: H₂→2H⁺+2e⁻

The H⁺ ion generated on the anode side moves toward the cathode side through the solid polyelectrolyte 14, and the e⁻ (electron) generated on the anode side moves toward the cathode side through an external load.

While on the cathode side, the oxygen contained in the oxidizer gas is reacted with the H⁺ ion and the e⁻ moved from the anode side to form water. As a result, in the aforesaid fuel cell, DC power is generated from hydrogen and oxygen, and meanwhile water is formed.

Next, an electric storage device having an electrode material to which the aforesaid carbon catalyst is applied will be described below.

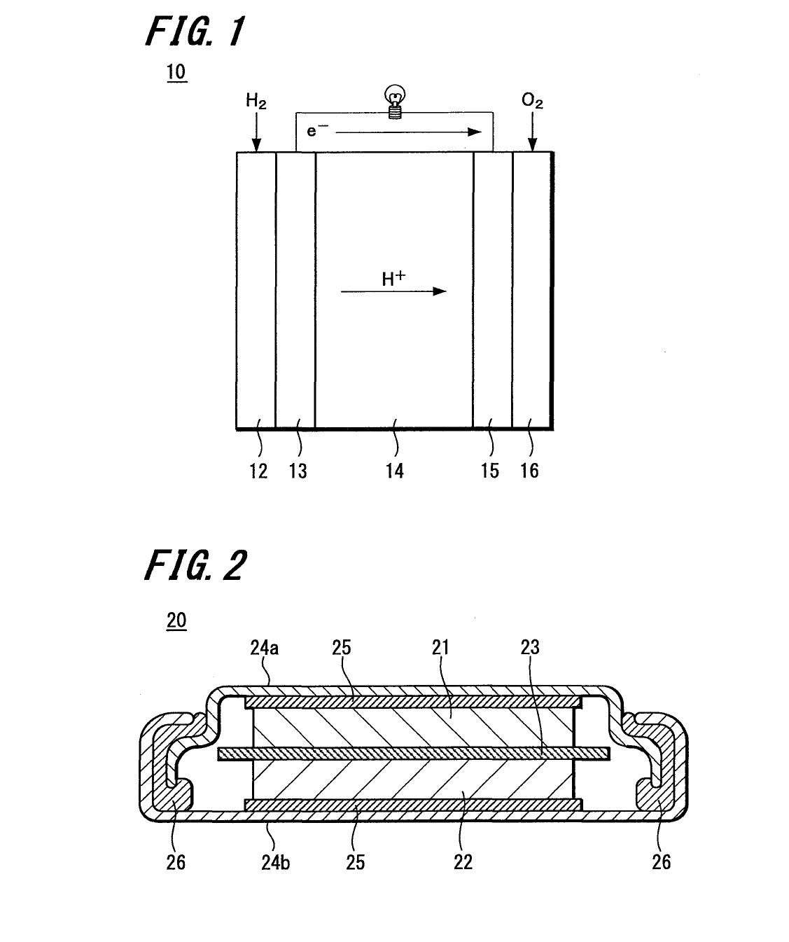

FIG. 2 is a view showing a schematic configuration of an electric double layer capacitor 20 excellent in electric storage capacity, as an example of the electric storage device of the present embodiment.

The electric double layer capacitor 20 shown in FIG. 2 includes a first electrode (a polarized electrode) 21, a second electrode (a polarized electrode) 22, a separator 23, an exterior lid 24a and an exterior case 24b. The first electrode 21 and the second electrode 22 face each other with the separator 23 interposed therebetween, and the exterior lid 24a and exterior case 24b accommodate the first electrode 21, the second electrode 22 and the separator 23. Further, the first electrode 21 and the second electrode 22 are respectively connected to the exterior lid 24a and the exterior case 24b through a current collector 25. Further, the separator 23 is impregnated with an electrolytic solution. Further, the exterior lid 24a and the exterior case 24b are sealed to each other by caulking with a gasket 26 interposed therebetween to electrically-insulate the exterior lid 24a and exterior case 24b from each other, and thereby the electric double layer capacitor 20 is configured.

In the electric double layer capacitor 20 of the present embodiment, the aforesaid carbon catalyst can be applied to both the first electrode 21 and the second electrode 22. Further, it is possible to configure the electric double layer capacitor having the electrode material to which the carbon catalyst is applied.

The aforesaid carbon catalyst has a fibrous structure formed by aggregated nanoshell carbon, and further, since the diameter of the fibers is measured in nanometer, the carbon catalyst has large specific surface area, and therefore the capacitor has large electrode interface where charges accumulate. Further, since the aforesaid carbon catalyst is electrochemically inactive in the electrolytic solution and has proper electrical conductivity, by applying the carbon catalyst to the electrodes of the capacitor, capacitance per unit volume of the electrodes can be improved.

Further, similar to the aforesaid capacitor, the aforesaid carbon catalyst can be applied to other electrodes formed of carbon material, such as negative-electrode material of a lithium-ion secondary battery. Further, since the specific surface area of the carbon catalyst is large, it is possible to configure a secondary battery with large electric storage capacity.

Next, examples of using the aforesaid carbon catalyst as an alternative to an environmental catalyst containing a noble metal such as platinum will be described below.

An environmental catalyst configured by a catalyst material formed of a noble metal-based material, such as a platinum-based material, alone or in combination is used as an exhaust gas purging catalyst for removing contaminated materials (mainly gaseous substances) contained in the contaminated air by performing degradative treatment.

The aforesaid carbon catalyst can be used as an alternative to the exhaust gas purging catalyst which contains a noble metal such as platinum. The aforesaid carbon catalyst is provided with catalytic action by the nanoshell carbon, and therefore has degradation function for degrading material-to-be-treated such as the contaminated material.

Thus, since the noble metal such as platinum is unnecessary to be used to configure the environmental catalyst with the aforesaid carbon catalyst, it is possible to provide a low-cost environmental catalyst. Further, since the specific surface area is large, treatment area (in which the material-to-be-treated is degraded) per unit volume can be increased, and therefore it is possible to configure an environmental catalyst excellent in degradation function per unit volume.

Incidentally, by carrying a noble metal-based material used in a conventional environmental catalyst, such as a platinum-based material, alone or in combination on the carbon catalyst, it is possible to configure an environmental catalyst more excellent in catalytic action such as degradation function and the like.

Incidentally, the environmental catalyst having the aforesaid carbon catalyst may also be used as catalysts for liquid phase reactions such as a catalyst for water treatment, in addition to being used as catalysts for gas phase reactions such as the aforesaid exhaust gas purging catalyst.

Further, the aforesaid carbon catalyst can be used as catalyst for various kinds of reactions, and among these, as an alternative to the platinum catalyst. In other words, the aforesaid carbon catalyst can be used as an alternative to a generic process catalyst containing noble metal such as platinum used in the chemical industry. Thus, with the aforesaid carbon catalyst, it is possible to provide a low-cost chemical reaction process catalyst without using expensive noble metals such as platinum. Further, since the aforesaid carbon catalyst has large specific surface area, it is possible to provide a chemical reaction process catalyst excellent in chemical reaction efficiency per unit volume.

Such a carbon catalyst for chemical reactions can be applied to, for example, catalysts for hydrogenation reactions, catalysts for dehydrogenation reactions, catalysts for oxidation reactions, catalysts for polymerization reactions, catalysts for reforming reactions, steam reforming catalysts and the like. To be more specific, the carbon catalyst can be applied to various chemical reactions by referring to documents relating to catalysts, such as “Catalyst Preparation (Kodansha), T. Shirasaki and N. Todo, 1975”.

### EXAMPLES

The present invention will be described below in detail by giving examples and comparative examples. However it should be understood that the present invention is not limited to the Examples below. Incidentally, the following evaluation items in the examples and comparative examples were conducted using below methods.

### [1] Average Fiber Diameter

50 fibers were randomly-selected from a photo of a specimen surface photographed by a scanning electron microscope (JSM-6701F, manufactured by JEOL) at a magnification of 10000×, the fiber diameter of the selected fibers was measured, and arithmetic average of the measured values was calculated as the average fiber diameter.

### [2] Average Thickness of Graphene Layer

Particle size of the nanoshell carbon and morphology of the fiber were observed using a transmission electron microscope (JSM-2010, manufactured by JEOL). 10 nanoshell carbons existing on the surface of the carbon catalyst were randomly-selected from an image obtained by the observation, the thickness of the graphene layer constituting the nanoshell carbon was measured, and arithmetic average of the measured values was calculated as the average thickness of the graphene layer.

### [3] X-Ray Diffraction (XRD)

X-ray diffraction was measured using a powder X-ray diffractometer (RINT2100V/PC, manufactured by Rigaku Corporation). CuKα radiation was used as an X-ray source.

### [4] Ratio of Surface Nitrogen Amount to Surface Carbon Amount (N/C)

In order to confirm composition of the surface of the specimen and chemical state of nitrogen atoms (N), the specimen was measured using an X-ray photoelectron spectroscopy (ESCA5600, manufactured by Perkin Elmer). AlKα radiation (15 KV, 350 W) was used as an X-ray source. In the obtained spectra, the peak of C1s spectrum was at 284.5 eV, and on that basis the binding energy was calibrated. Further, surface element concentration of N, C, and O (at %) is obtained based on peak area and detection sensitivity coefficient of each spectrum so as to calculate N/C.

### [5] Elemental Analysis

The content of nitrogen atoms (N) contained in the carbon catalyst (mass %) was measured using CHN corder (MT-6, manufactured by Yanaco Analytical Instruments Corporation).

### [6] Electrocatalytic Activity Test on Oxygen Reduction

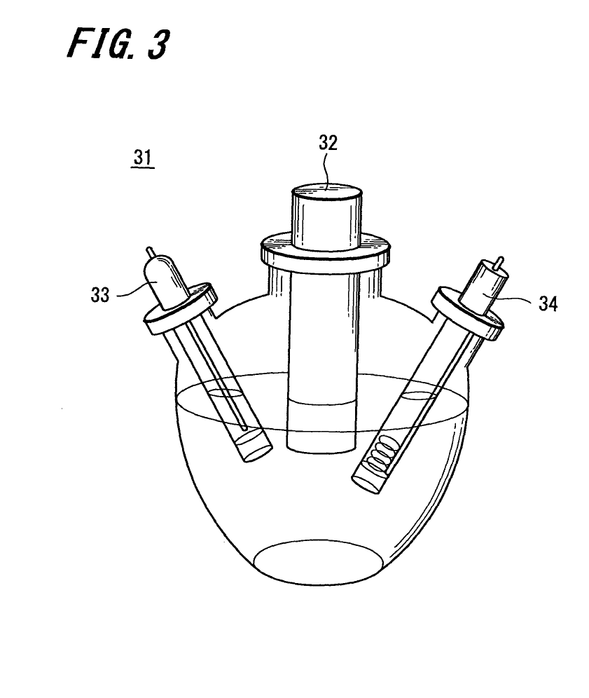

Electrocatalytic activity test on oxygen reduction was measured using a three-electrode cell 31 schematically shown in FIG. 3. To be specific, the three-electrode cell 31 has a working electrode (a rotating electrode) 32 arranged in a central portion thereof. The working electrode 32 is provided with a polymer insulator on the periphery thereof and an electrode portion in the central portion thereof, wherein the electrode portion is formed of glassy carbon. The electrode portion is coated with each slurry (a mixture obtained by mixing catalyst 5 mg, ethanol 150 μl, pure water 150 μl, and Nafion (manufactured by Sigma-Aldrich, perfluorinated ion-exchange resin, 5 wt % in mixture of lower aliphatic alcohols and water) 50 μl) prepared as described below. Further, the three-electrode cell 31 is also provided with a reference electrode (Ag/AgCl) 33 and a counter electrode (Pt) 34, wherein the reference electrode 33 is on the left of the working electrode 32, and the counter electrode 34 is on the right of the working electrode 32 when viewing FIG. 3.

### [7] Activity for Oxygen Reduction Reaction

In a voltammogram obtained based on the electrocatalytic activity test, the current density at a potential of 0.7V is regarded as the value of the activity for oxygen reduction reaction.

### Example 1

### Preparation of Polyacrylonitrile-Polymethacrylic Acid Copolymer (PAN-co-PMA)

Acrylonitrile (manufactured by Wako Pure Chemical Industries, Ltd.) 30.93 g, methacrylic acid (manufactured by Wako Pure Chemical Industries, Ltd.) 4.07 g and pure water 300 ml were put into a four-necked flask, and bubbling was conducted for 15 minutes by using nitrogen gas. Next, the flask was immersed into an oil bath to adjust the temperature of the flask to 70° C. Further, a solution prepared by dissolving 100 mg of potassium peroxydisulfate (manufactured by Wako Pure Chemical Industries, Ltd.) in 50 ml of pure water was injected into the flask, which had been adjusted to 70° C., and stirred for four hours under a nitrogen gas atmosphere so as to be polymerized. Thereafter, the flask was cooled to obtain a milky-white solution.

Next, the milky-white solution was concentrated, and then the concentrated solution was vacuum-dried at a temperature of 60° C. to obtain about 20 g of polyacrylonitrile-polymethacrylic acid copolymer (PAN-co-PMA).

### Preparation of Cobalt Compound-Added Pan-co-PMA Fibers (Nanofibers)

0.18 g of cobalt oxide (NANOTEC, average particle size 25 nm, manufactured by CI Kasei Co., Ltd) was sufficiently dispersed in 94 g of dimethylformamide (manufactured by Wako Pure Chemical Industries, Ltd.), and then 5.82 g of the aforesaid PAN-co-PMA was dissolved to obtain a solution for spinning. At this time, the content of the cobalt oxide was 3% by mass based on the total solid content, and the content of the total solid content was 6% by mass based on the total solution.

The solution for spinning was spun using an electrospinning method to obtain a nanofiber nonwoven fabric under conditions of: applied voltage: 25-28 KV; discharge pressure: 3-7 kPa; discharging tip inner diameter: 0.31 mmΦ; and distance between the nozzle and the connector: 0.15-0.2 m.

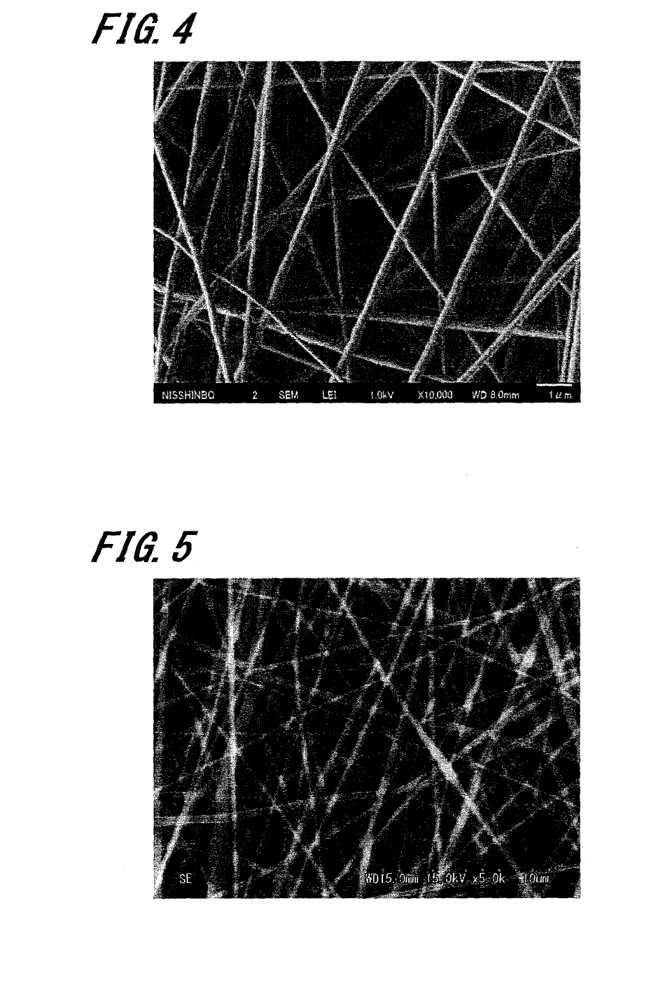

FIG. 4 shows an image of the obtained nanofiber nonwoven fabric taken by a scanning electron microscope (SEM). The average fiber diameter of the nanofiber nonwoven fabric was 270 nm.

### Infusibilization Process

The nanofiber nonwoven fabric obtained using the aforesaid method was set into a forced circulation-type dryer with four edges thereof clipped by clips. Further, in the air, the temperature of the nanofiber nonwoven fabric was raised from room temperature to 150° C. over 30 minutes, then raised from 150 to 220° C. over 2 hours, and then the temperature was maintained at 220° C. for 3 hours, thereby the infusibilization of the nanofiber nonwoven fabric is completed.

### Carbonization Process

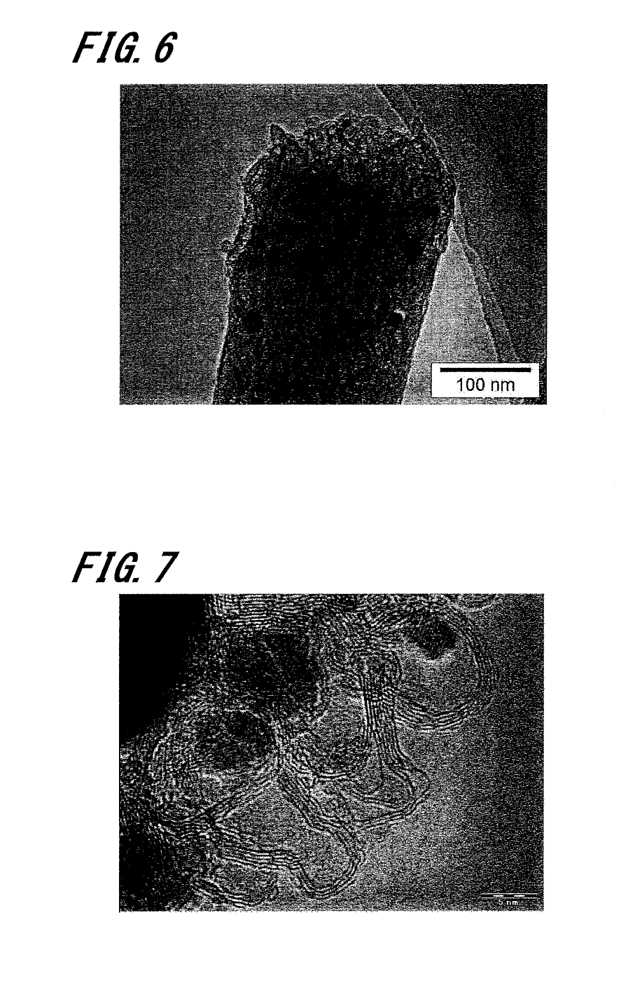

The nanofiber nonwoven fabric having subjected to the aforesaid infusibilization process was put into a quartz tube to be subjected to nitrogen gas purge for 20 minutes in an ellipsoidal reflection type infrared gold image furnace and then the temperature was raised from room temperature to 900° C. over 1.5 hours. Thereafter, the temperature was held at 900° C. for one hour, and thereby the carbonization process of the nanofiber nonwoven fabric was completed. SEM image of the carbonized nanofibers is shown in FIG. 5. TEM image of the carbonized nanofibers is shown in FIG. 6, and further enlarged TEM image is shown in FIG. 7.

It could be confirmed from the SEM image of FIG. 5 that, in the carbonized nanofibers, carbon nanofibers having average fiber diameter of 210 nm are collected.

Further, in the TEM image shown in FIG. 6, the circular black parts are cobalt oxide; and in the TEM image shown in FIG. 7, the slit-like parts are graphene layers existing on the surface of the carbon nanofiber. It can be confirmed from the TEM images of FIGS. 6 and 7 that, in the surface of the carbon nanofiber, the thickness of the graphene layer is within a range of 1 to 3 nm, and a large number of spherical and non-spherical nanoshell carbons having a particle size of 20 nm or less are generated and collected.

### Crushing Process

Zirconia balls having a size of 1.5 mmΦ were set in a planetary ball mill (P-7, manufactured by Fritsch) to crush the specimen obtained using the aforesaid method at a rotational speed of 800 rpm for 5 minutes. The crushed specimen was taken out and sieved using a sieve having a mesh size of 105 μm, and the crushed specimen passed through the sieve is the carbon catalyst of Example 1.

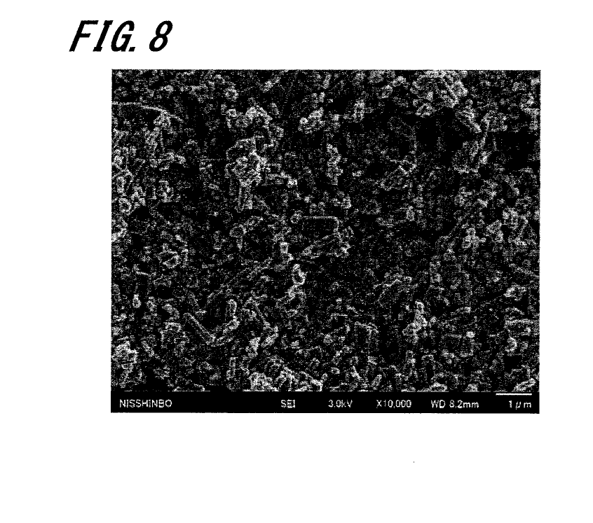

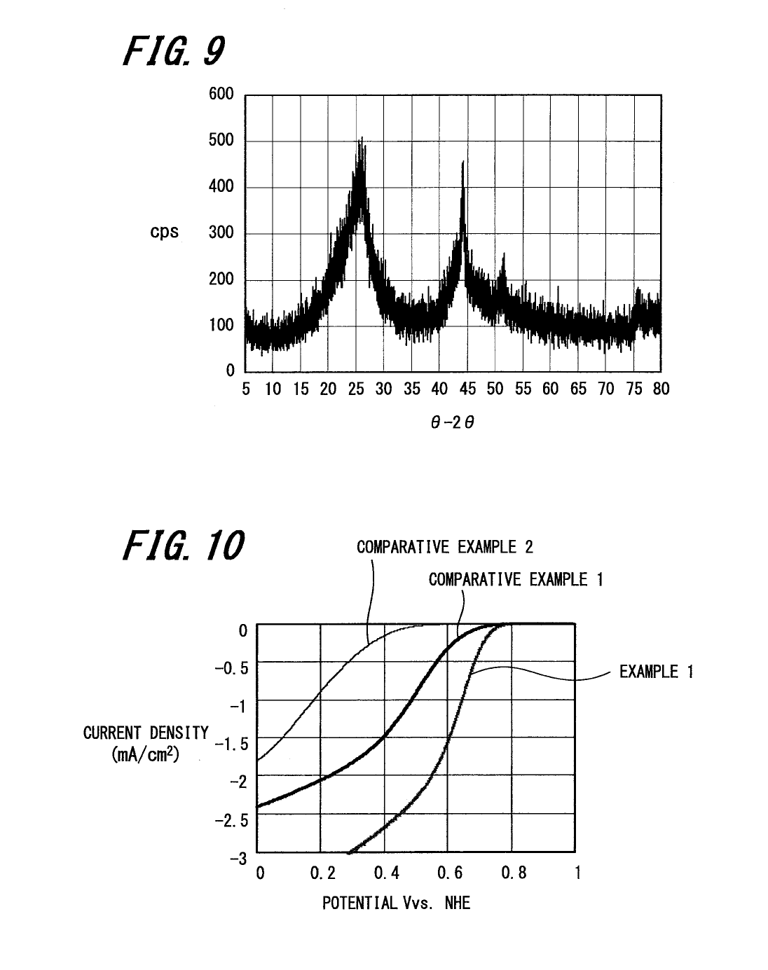

FIG. 8 is the SEM image of the carbon catalyst of Example 1 passed through the sieve. FIG. 9 is the XRD spectrum of the carbon catalyst of Example 1 passed through the sieve.

Further, the activity for oxygen reduction reaction of the carbon catalyst of Example 1 was measured, and the voltammogram obtained based on the electrocatalytic activity test is shown in FIG. 10, and the value of the activity for oxygen reduction reaction is shown in Table 1. Further, the content of the nitrogen atom (N) of the carbon catalyst of Example 1 was measured, and the content of the nitrogen atom based on the total weight of the carbon catalyst (mass %), the surface nitrogen amount (N/C) and the average thickness of the graphene layer are shown in Table 1.

### Example 2

Example 2 was identical to Example 1 except that the cobalt oxide in Example 1 was changed into the cobalt chloride (manufactured by Wako Pure Chemical Industries, Ltd.) and, in the preparation of the solution for spinning, the content of the cobalt chloride was 6% by mass based on the total solid content. The activity for oxygen reduction reaction of the carbon catalyst obtained in Example 2 was measured, and the value of the activity for oxygen reduction reaction is shown in Table 1.

### Example 3

### Carbon Dioxide Activation

The nanofibers were carbonized using the same method as that of Example 1. After crushing treatment, the obtained carbon nanofibers were put into a quartz tube to be subjected to a carbon dioxide gas purge for 20 minutes in an ellipsoidal reflection type infrared gold image furnace, and then the temperature was raised from room temperature to 750° C. over 37 minutes. Thereafter, the temperature was held at 750° C. for one hour, and carbon dioxide activation was performed on the carbonized nanofibers. By using such a method, the carbon catalyst of Example 3 was obtained. The activity for oxygen reduction reaction of the carbon catalyst of Example 3 was measured, and the value of the activity for oxygen reduction reaction is shown in Table 1.

### Example 4

### Nitrogen (N) Dope

### Ammoxidation Method

The nanofibers were carbonized using the same method as that used in Example 2. After crushing treatment, carbon dioxide activation was performed on the carbon nanofibers. Further, the carbon nanofibers having subjected to the carbon dioxide activation were put into a quartz tube to be subjected to a nitrogen gas purge for 20 minutes in an ellipsoidal reflection type infrared gold image furnace, and then the temperature was raised from room temperature to 600° C. over 20 minutes. Thereafter, the temperature was held at 600° C. for two hours, and the carbon nanofibers were doped with nitrogen (N). By using such a method, the carbon catalyst of Example 4 was obtained. The activity for oxygen reduction reaction of the carbon catalyst of Example 4 was measured, and the value of the activity for oxygen reduction reaction is shown in Table 1. Further, the surface nitrogen amount (N/C) is shown in Table 1.

### Example 5

Example 5 was identical to Example 1 except that the cobalt oxide in Example 1 was changed into the phthalocyanine iron (manufactured by Wako Pure Chemical Industries, Ltd.) and, in the preparation of the solution for spinning, the content of the phthalocyanine iron was 3% by mass based on the total solid content. The activity for oxygen reduction reaction of the carbon catalyst obtained in Example 5 was measured, and the value of the activity for oxygen reduction reaction is shown in Table 1.

### Example 6

In Example 6, a nonwoven fabric was produced by a wet spinning method using the solution for spinning of Example 1. The details of the wet spinning method are the following.

First, the solution for spinning of Example 1 was injected into warm water of 40° C. with a 50-cc Terumo Syringe (trade name) to prepare a fibrous carbon precursor. Next, the prepared fibrous carbon precursor was taken out from the warm water, dried under reduced pressure at 40° C. to produce the nonwoven fabric.

The carbon catalyst of Example 6 was obtained by the same method as that used in Example 1 except for the step of forming the nonwoven fabric. The average fiber diameter of the obtained carbon catalyst was 52 μm. The activity for oxygen reduction reaction of the carbon catalyst of Example 6 was measured, and the value of the activity for oxygen reduction reaction is shown in Table 1.

### Example 7

The solution for spinning was prepared using the same method as that used in Example 1 except that the content of the dimethylformamide (manufactured by Wako Pure Chemical Industries, Ltd.) was 34 g and the content of the total solid content concentration was 15%, with the contents of the PAN-co-PMA and cobalt oxide unchanged. Further, similar to Example 6, the nonwoven fabric was produced by a wet spinning method.

The carbon catalyst of Example 7 was obtained using the same method as that used in Example 1 except for the step of forming the nonwoven fabric. The average fiber diameter of the obtained carbon catalyst was 622 μm. The activity for oxygen reduction reaction of the carbon catalyst of Example 7 was measured, and the value of the activity for oxygen reduction reaction is shown in Table 1.

### Comparative Example 1

Methanol (manufactured by Wako Pure Chemical Industries, Ltd.) 100 ml was mixed with furfuryl alcohol (manufactured by Wako Pure Chemical Industries, Ltd.) 10 g to prepare a mixed solution, and a cobalt phthalocyanine complex (manufactured by Wako Pure Chemical Industries, Ltd.) 2.090 g and melamine (manufactured by Wako Pure Chemical Industries, Ltd.) 7.499 g were added into the mixed solution, and the mixture was stirred at room temperature for one hour with a magnetic stirrer. The solvent was removed with a rotary evaporator at 60° C. while irradiating ultrasonic waves to the mixture, and then the resultant was moved to a dish, the dish was put under a nitrogen gas atmosphere of a pressure of 0.1 MPa at 80° C. and held in such a state for 24 hours, so that a polymerization reaction occurred to synthesize a polyfurfuryl alcohol (carbon precursor polymer) containing a cobalt phthalocyanine complex and melamine.

After the carbonization process, the same steps as those of Example 1 are performed to obtain the carbon catalyst of Comparative Example 1. The voltammogram obtained based on the electrocatalytic activity test is shown in FIG. 10, and the value of the activity for oxygen reduction reaction is shown in Table 1. Further, the content of nitrogen atom (N) of the carbon catalyst of Comparative Example 1 was measured, and the content of nitrogen atom based on the total weight of the carbon catalyst (mass %), the surface nitrogen amount (N/C) and the average thickness of the graphene layer are shown in Table 1.

### Comparative Example 2

The carbon catalyst of Comparative Example 2 was obtained using the same method as that used in Example 1 except that the cobalt oxide of Example 1 was not added. The activity for oxygen reduction reaction of the carbon catalyst of Comparative Example 2 was measured, and the voltammogram obtained based on the electrocatalytic activity test is shown in FIG. 10, and the value of the activity for oxygen reduction reaction is shown in Table 1. Further, the content of nitrogen atom (N) of the carbon catalyst of Comparative Example 2 was measured, and the content of nitrogen atom based on the total weight of the carbon catalyst (mass %) is shown in Table 1. Incidentally, in Comparative Example 2, there was no nanoshell carbon.

TABLE 1

| | Activity for | | | |
|---|---|---|---|---|
| | oxygen reduction | | Average thickness | |
| | reaction | | of graphene layer | |
| | (mV/cm2) | N % | (nm) | N/C |
| Example 1 | −0.341 | 6.61 | 2.5 | 4.0 |
| Example 2 | −0.295 | — | — | — |
| Example 3 | −0.350 | — | — | — |
| Example 4 | −0.502 | — | — | 10.3 |
| Example 5 | −0.234 | — | — | — |
| Example 6 | −0.205 | — | — | |
| Example 7 | −0.170 | — | — | |
| Comparative | −0.051 | 0.98 | 11.3 | 0.8 |
| example 1 | | | | |
| Comparative | −0.11 | 8.99 | graphene not | — |
| example 2 | | | confirmed | |

Note that, “-” in the table means the item was not measured.

It is known from the shape of the voltammogram shown in FIG. 10 that, compared with the carbon catalyst of Comparative Example 1 and the carbon catalyst of Comparative Example 2, the carbon catalyst of Example 1 can obtain large current density at a higher potential. Further, it is known that the carbon catalyst less changes in potential in response to the change of the current density. Further, it is known from Table 1 that the value of the activity for oxygen reduction reaction of the carbon catalyst of Example 1 at a potential of 0.7V is −0.341 mV/cm², which means the carbon catalyst of Example 1 has larger current than that of the carbon catalyst of Comparative Examples 1 and 2 at a high potential.

Thus, it is known that, in the carbon catalyst of Example 1, the content of nitrogen atom (N) is high and the fibrous structure is formed by aggregated fine nanoshell carbon, and therefore the carbon catalyst is more excellent in activity for oxygen reduction reaction compared with the carbon catalyst of Comparative Example 1 and the carbon catalyst of Comparative Example 2, which have no such structure.

Further, in the case where the carbon catalyst is applied to the cathode of a fuel cell, for example, it is preferred that a large current is flowed at a potential as high as possible, and also, it is preferred that a stable potential is obtained when the current is flowed. Thus, by applying the carbon catalyst of Example 1 to the electrode catalyst of a fuel cell, it is possible to obtain a fuel cell which contains no noble metal such as platinum or the like yet has excellent properties.

It should be understood that the present invention is not limited to the aforesaid configurations, but includes various other configurations without departing from the spirit of the present invention.

What is claimed is:

1. A carbon catalyst formed by carbon particles of nanoshell structure, wherein the carbon catalyst is formed in fibrous shape, and the carbon particles of nanoshell structure are provided with catalytic action.

2. The carbon catalyst according to claim 1, wherein the carbon particles of nanoshell structure contain nitrogen atoms and/or boron atoms.

3. The carbon catalyst according to claim 1, wherein the diameter of the carbon catalyst is within a range of 0.01 to 1000 μm.

4. The carbon catalyst according to claim 1, wherein the thickness of graphene layers which constitute the carbon particles of nanoshell structure is within a range of 1 to 10 nm.

5. The carbon catalyst according to claim 1, wherein the size of the carbon particles is within a range of 5 to 50 nm.

6. The carbon catalyst according to claim 2, wherein the total content of nitrogen atom and/or boron atom is within a range of 0.5 to 20% by mass based on the total weight of the carbon catalyst.

7. The carbon catalyst according to claim 1, wherein the carbon catalyst contains a transition metal or a compound of the transition metal.

8. The carbon catalyst according to claim 7, wherein the transition metal or the compound of the transition metal is at least one substance selected from a group consisting of cobalt (Co), iron (Fe), manganese (Mn), nickel (Ni), copper (Cu), titanium (Ti), chromium (Cr), zinc (Zn), cobalt chloride, cobalt oxide, phthalocyanine cobalt, iron chloride, iron oxide and phthalocyanine iron.

9. The carbon catalyst according to claim 1, wherein the carbon catalyst is made in nonwoven fabric form.

10. The carbon catalyst according to claim 1, wherein the carbon catalyst can be applied to an electrode catalyst for a fuel cell, an electrode material of an electric storage device, an exhaust gas purging catalyst, a catalyst for water treatment, a catalyst for hydrogenation reaction, a catalyst for dehydrogenation reaction, a catalyst for oxidation reaction, a catalyst for polymerization reaction, a catalyst for reforming reaction, and a steam reforming catalyst.

11. A method for producing a carbon catalyst comprising the steps of:
preparing a carbon precursor polymer;
mixing a transition metal or a compound of the transition metal into the carbon precursor polymer;
spinning the mixture of the carbon precursor polymer and the transition metal or the compound of the transition metal into fibers; and
carbonizing the fibers to form carbon particles of nanoshell structure.

12. The method for producing the carbon catalyst according to claim 11, wherein the carbon precursor polymer is a polymer containing nitrogen atom and/or boron atom.

13. The method for producing the carbon catalyst according to claim 11, wherein part or the whole of the carbon precursor polymer contains polyacrylonitrile or a copolymer thereof.

14. The method for producing the carbon catalyst according to claim 11, wherein the transition metal or the compound of the transition metal is at least one substance selected from a group consisting of cobalt (Co), iron (Fe), manganese (Mn), nickel (Ni), copper (Cu), titanium (Ti), chromium (Cr), zinc (Zn), cobalt chloride, cobalt oxide, phthalocyanine cobalt, iron chloride, iron oxide and phthalocyanine iron.

15. The method for producing the carbon catalyst according to claim 11, further comprising a step of introducing nitrogen and/or boron into the fibers after the fiber is carbonized.

16. A slurry comprising:
a solvent; and
a carbon catalyst dispersed in the solvent,
wherein the carbon catalyst is formed in fibrous shape by carbon particles of nanoshell structure, and
wherein the carbon particles of nanoshell structure are provided with catalytic action.

17. A fuel cell comprising:
a solid electrolyte; and
two electrode catalysts facing each other with the solid electrolyte interposed therebetween,
wherein at least one of the electrode catalysts includes a carbon catalyst which is formed in fibrous shape by carbon particles of nanoshell structure, and
wherein the carbon particles of nanoshell structure are provided with catalytic action.

18. An electric storage device comprising:
an electrode material; and
an electrolyte,
wherein the electrode material includes a carbon catalyst formed in fibrous shape by carbon particles of nanoshell structure, and
wherein the carbon particles of nanoshell structure are provided with catalytic action.

19. An environmental catalyst for removing contaminated material by performing degradative treatment, comprising:
a carbon catalyst formed by carbon particles of nanoshell structure,
wherein the carbon catalyst is formed in fibrous shape, and the carbon particles of nanoshell structure are provided with catalytic action.
